(19) United States
(12) Patent Application Publication
(10) Pub. No.: US 2006/0243579 A1
(43) Pub. Date: Nov. 2, 2006

(54) Foil-type switching element with dielectric layer

(76) Inventors: Werner Bieck, Wiltingen (DE); Driss Chabach, Noertrange (LU); Yves Decoster, Ethe (BE); Manuel Ruggiu, Linger (LU)

Correspondence Address: CANTOR COLBURN, LLP, 55 GRIFFIN ROAD SOUTH, BLOOMFIELD, CT, 06002, US

(21) Appl. No.: 10/538,400

(22) PCT Filed: Dec. 8, 2003
(86) PCT No.: PCT/EP03/50962

§ 371 Date: Nov. 14, 2005

(30) Foreign Application Priority Data
Dec. 9, 2002 (EP) 02102705.7

(51) Int. Cl. H01H 1/02

(52) U.S. Cl. 200/511

(57) ABSTRACT

A foil-type switching element includes a first carrier foil and a second carrier foil arranged at a certain distance from each other by means of a spacer, the spacer including at least one recess defining an active area of the switching element. At least two electrodes are arranged in the active area of the switching element between the first and second carrier foils in such a way that, in response to a pressure acting on the active area of the switching element, the first and second carrier foils are pressed together against the reaction force of the elastic carrier foils and an electrical contact is established between the at least two electrodes. In order to avoid inhomogeneous deformation of the carrier foil due to the application of the electrodes, the switching element further comprises a layer of dielectric material, the dielectric material being applied onto the first carrier foil between the carrier foil and an electrode arranged on the first carrier foil, the layer of dielectric material covering at least an electrode region of the first carrier foil which is delimited by a generally outer periphery of the electrode arranged on the first carrier foil.

The present invention relates to foil-type switching elements and more specifically to foil-type switching elements comprising at least one electrode structure printed on a flexible carrier foil.

The present invention relates to a foil-type switching element comprising a first carrier foil and a second carrier foil arranged at a certain distance from each other by means of a spacer. The spacer comprises at least one recess, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure sensors having an electrical resistance, which varies with the amount of pressure applied. In a first embodiment of such pressure sensors, a first electrode is arranged on the first carrier foil and a second electrode is arranged on the second carrier foil in facing relationship with the first electrode. At least one of the electrodes is covered by a layer of pressure sensitive material, e.g. a semi-conducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of the pressure sensors, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice.

The electrical response of such a switching element depends on the type of the electrodes, the presence of a possible layer of pressure sensitive material, the design of the electrodes and their arrangement within the active area of the switching element and finally on the physical contact, which is established between the electrodes in response to a force acting on the active area. The physical contact between the electrodes is determined by the mechanical response of the switching element in case of a force acting on the active area. This mechanical response depends on the elastic properties of the carrier foils, usually a PET foil, the lateral dimension of the active area and the distance between the two opposed carrier foils.

During the manufacturing process, the electrodes are usually printed onto their respective carrier foil. During this printing process, the carrier foil is subject to surface tensions on the boundary to the conductive material of printed electrode. These surface tensions may lead to a deformation of the carrier foil, which depending on the configuration of the electrode may be inhomogeneous over the active area of the switching element.

The uncontrolled deformations of the carrier foil and the printed electrode alter of course the configuration of the switching element in the active area. In fact, the distance between the two carrier foils differs from the nominal distance and is no longer uniform over the entire area of the active zone. Furthermore the electrodes being subject to the same deformations, the configuration of the electrode does no longer match with the specifications. These factors result in an uncontrolled modification of the mechanical response of the sensor and accordingly to a modification of its electrical response.

### OBJECT OF THE INVENTION

The object of the present invention is to provide an improved foil-type switching element.

### GENERAL DESCRIPTION OF THE INVENTION

This object is achieved by a foil-type switching element according to claim 1. This foil-type switching element comprises a first carrier foil and a second carrier foil arranged at a certain distance from each other by means of a spacer, said spacer comprising at least one recess defining an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes. According to the invention, the switching element further comprises a layer of dielectric material, said dielectric material being applied onto said first carrier foil between the carrier foil and an electrode arranged on said first carrier foil, said layer of dielectric material covering at least an electrode region of the first carrier foil which is delimited by a generally outer periphery of the electrode arranged on said first carrier foil.

The electrode region in which the dielectric material is applied is delimited by a generally convex outline circumscribing the electrode to be printed on the carrier foil. It follows that even in the case of complex electrode configurations, e.g. in the case of comb-shaped electrodes, the region in which a material is applied directly to the carrier foil has a generally convex form. The application of a layer of dielectric material, which covers the entire electrode region, thus prevents the substrate to deform inhomogeneously in the electrode region of the active area. Even if the carrier foil deforms as a result of the application of the dielectric layer, such deformation is substantially homogeneous over the electrode region and may accordingly controlled or compensated. Accordingly, the configuration of the electrodes and carrier foil arrangement is not altered in an uncontrolled manner by the manufacturing process so that the production of switching elements which are not conform to the specifications can be considerably reduced.

The dielectric material can be chosen from a wide range of suitable materials, such as e.g. PUR resin, epoxy resin, phenoxy resin, silicone resin, etc. It should be noted that the dielectric material is preferably chosen so as to reduce the stress at the boundary layer between the carrier foil and the application layer such that the deformation of the carrier foil during the application thereof is minimized. It will further be noted that the dielectric layer may also act as a primer, which enhances the adhesion of the printed conductive electrode material, e.g. a silver ink.

Depending on the dielectric material and on the thickness of the dielectric layer, the mechanical properties of the membrane system (carrier foil & dielectric layer) may be influenced by the application of a suitable dielectric material. It is for instance possible to increase the stiffness of the membrane so as to control the deflection of the membrane under the action of a pressure acting on the active area of the switching element. It follows that the mechanical response of the switching element may be influenced in a controlled manner by the application of a suitable dielectric material.

It will be noted that an electrode having a convex form, e.g. a disk shaped electrode, is less susceptible to cause inhomogeneous deformations of the carrier foil than an electrode having a complex configuration such as an electrode having a comb-shaped form, or the form of a ring segment or any other non-convex form. In fact, such complex configuration of the electrode, e.g. a comb-shaped electrode, an electrode in the form of a ring segment, is the main cause for inhomogeneous deformation of the carrier foil. It follows that the layer of dielectric material is preferably applied to the carrier foil, onto which an electrode having a complex configuration is to be printed.

However in a preferred embodiment of the invention, a layer of dielectric material is applied on each of said carrier foils, independent of the configuration of the electrode(s). It follows that in this embodiment, a layer of dielectric material is also applied onto said second carrier foil between the second carrier foil and an electrode arranged on said second carrier foil. This embodiment of the switching element has the advantage, that both carrier foils are provided with similar mechanical properties and that accordingly the switching element shows a similar mechanical or electrical response independently of the side on which a force is acting on the active area.

It will however be noted, that depending on the application, the different dielectric layers of both carrier foils may be made of a different material or have a different thickness, such that the mechanical properties of the first and the second membrane system differ from each other and the switching element shows an asymmetric behaviour.

In a preferred embodiment of the invention, the layer of dielectric material is applied on the respective carrier foil in substantially the entire area of said active area. The coating of the entire area of the active area ensures that any deformation caused by the application of the dielectric layer will be homogenous over the entire active area of the switching element. Furthermore, inhomogeneous deformations due to a misalignment of the printed electrode in the active area are effectively excluded.

In a variant of this embodiment, the said layer of dielectric material is applied on the respective carrier foil in the entire area of said active area and extends laterally beyond said active area. This means that an outer border of the layer of dielectric material is arranged between the carrier foil and the spacer material.

With this embodiment, the entire area of the active zone is reliably covered even in the case of slight misalignment of the spacer and the carrier foil. The fabrication of switching element which are out of specification can thus be reduced.

In a further embodiment, the said layer of dielectric material is applied on the respective carrier foil on the complete surface of said carrier foil. While this embodiment increases the amount of dielectric material used, its fabrication process is considerably simplified compared with the fabrication process of the preceding embodiments.

In a very simple and cost-effective fabrication process, the layer of dielectric material is printed onto said carrier foil, e.g. by a screen printing process. Such printing processes are well known in the art and permit to apply high quality layers of printable materials in a desired thickness. It will be noted, that for general applications of the switching elements, the thickness of the dielectric layer should be as small as possible in order not to alter the mechanical properties of the carrier foil. The thickness of the dielectric layer will therefore usually be much smaller than the thickness of the carrier foil. One possible thickness of the dielectric layer is in the range of 10% of the thickness of the carrier foil. This ratio may however considerably vary in the case of specific applications. Furthermore, depending on the application and on the desired mechanical response of the switching element, the thickness of the dielectric layer may not be uniform over the entire area. In other words, depending on the embodiment of the switching element, the thickness of said layer of dielectric material varies over the active area.

The skilled person will appreciate, that the present invention is applicable to simple membrane switches as well as to pressure sensitive switches. In case of a simple membrane switch a first electrode is arranged on an inner surface of said first carrier foil and a second electrode is arranged on an inner surface of the second carrier foil in a facing relationship with said first electrode. In a variant of a simple switch, a first and a second electrode are arranged side by side on an inner surface of said first carrier foil and a shunt element is arranged on an inner surface of the second carrier foil in facing relationship with said first and second electrodes. The two electrodes may e.g. comprise a comb shaped configuration, with the teeth of the two electrodes being arranged in an interdigitating relationship. Foil-type pressure sensors are similarly configured as the above described switches. In contrast to the switches, at least one of said first and second electrode is covered by a pressure-sensitive resistive material. In an alternative embodiment, the said shunt element comprises a resistive material. Due to the pressure-sensitive resistive or semi-conducting material, the electrical resistance between the electrodes of these pressure sensors depends on the pressure with which the two carrier foils are pressed together.

### DETAILED DESCRIPTION WITH RESPECT TO THE FIGURES

The present invention will be more apparent from the following description of several not limiting embodiments with reference to the attached drawings, wherein

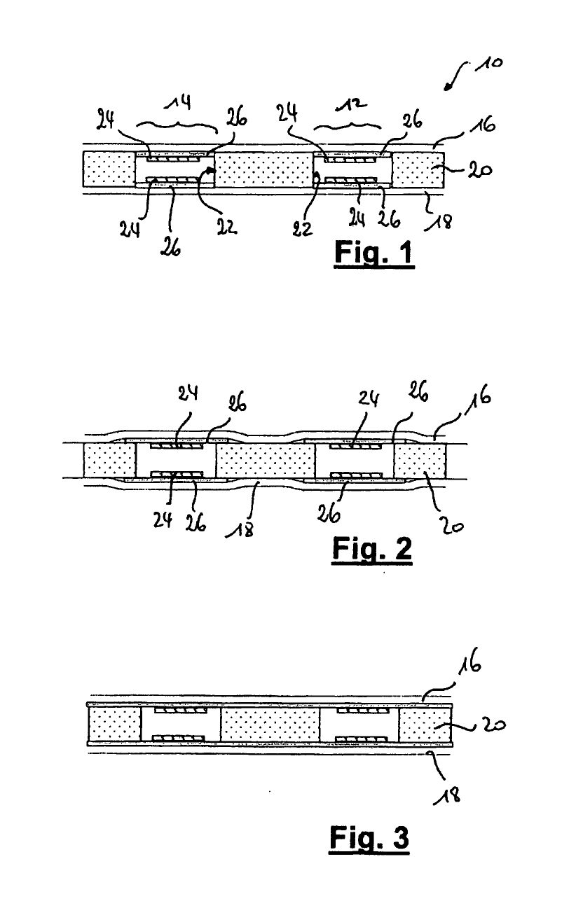

FIG. 1: shows an embodiment of a switching element having two active areas covered with dielectric material;

FIG. 2: shows an embodiment of a switching element having two active areas, wherein the layers of dielectric material extend beyond the active area

FIG. 3: shows an embodiment of a switching element having two active areas, wherein the layer of dielectric material covers the entire carrier foil.

Different embodiments of the present invention are schematically illustrated in the figures for a simple membrane switch 10 having two active areas 12 and 14. The switching element 10 comprises a first carrier foil 16 and a second carrier foil 18, which are arranged at a certain distance d by means of a spacer 20. The spacer 20 comprises two recesses or cut-outs 22 such that the spacer 20 surrounds the active areas 12 and 14 of the switching element 10. Electrodes 24 are arranged in each active area 12 and 14 on the inner surfaces of the carrier foils 16 and 18 in such a way that an electrical contact is established between the electrodes 24 if said carrier foils are pressed together. In the shown embodiment, one electrode 24 is arranged on each of said carrier foils in a facing relationship. It should however be noted that other layouts, e.g. with two spaced electrodes arranged on one of the carrier foils and a shunt element arranged on the second carrier foil, are also possible.

A layer of dielectric material 26 is applied on each carrier foil between the carrier foil and the respective electrode. The dielectric material is preferably printed onto the carrier foil at least in the entire electrode region, i.e. in a region, which is delimited by a generally convex outline circumscribing the electrode to be printed on the carrier foil. It follows that the electrode, which may have a complex configuration, is subsequently printed onto the layer of dielectric material.

In the embodiment of FIG. 1, the layers of dielectric material 26 covers the carrier foils 16 and 18 over the entire area of the respective active areas 12 or 14. In the embodiment shown in FIG. 2, the layer of dielectric material 16 is applied on the respective carrier foil in the entire area of said active area and extends laterally beyond said active area. The layer of dielectric material accordingly extends in the spacer region of the switching element. In the third embodiment shown in FIG. 3, the layer of dielectric material extends over the entire surface of the respective carrier foils.

### LIST OF REFERENCE SIGNS

10 switching element
12,14 active areas
16 first carrier foil
18 second carrier foil
20 spacer
22 recess or cut-out
24 electrodes
26 layer of dielectric material

1.-7. (canceled)

8. A foil-type switching element comprising:
a first carrier foil and a second carrier foil arranged at a certain distance from each other by means of a spacer, said spacer comprising at least one recess defining an active area of the switching element, and
at least two electrodes arranged in the active area of the switching element between said first and second carrier foils in such a way that, in response to a pressure acting on the active area of the switching element, the first and second carrier foils are pressed together against reaction force of the elastic carrier foils and an electrical contact is established between the at least two electrodes,
said foil-type switching element further comprising a layer of dielectric material, said dielectric material being applied onto said first carrier foil between the first carrier foil and an electrode arranged on said first carrier foil, said layer of dielectric material covering at least a region of the first carrier foil which is delimited by a generally outer periphery of the electrode arranged on said first carrier foil.

9. The foil-type switching element according to claim 8, wherein a layer of dielectric material is applied onto said second carrier foil between the second carrier foil and an electrode arranged on said second carrier foil.

10. The foil-type switching element according to claim 8, wherein said layer of dielectric material is applied on the first carrier foil in substantially an entire area of said active area.

11. The foil-type switching element according to claim 8, wherein said layer of dielectric material is applied on the first carrier foil in an entire area of said active area and extends laterally beyond said active area.

12. The foil-type switching element according to claim 8, wherein said layer of dielectric material is applied on the first carrier foil on a complete surface of said carrier foil.

13. The foil-type switching element according to claim 8, wherein said layer of dielectric material is printed onto said carrier foil.

14. The foil-type switching element according to claim 8, wherein a thickness of said layer of dielectric material varies over the active area.

15. The foil-type switching element according to claim 9, wherein said layer of dielectric material is applied on the second carrier foil in substantially an entire area of said active area.

16. The foil-type switching element according to claim 9, wherein said layer of dielectric material is applied on the second carrier foil in an entire area of said active area and extends laterally beyond said active area.

17. The foil-type switching element according to claim 9, wherein said layer of dielectric material is applied on the second carrier foil on a complete surface of said carrier foil.

18. A foil-type switching element comprising
a first carrier foil and a second carrier foil arranged at a certain distance from each other by means of a spacer, said spacer comprising at least one opening defining an active area of the switching element, and
at least two electrodes arranged in the active area of the switching element between said first and second carrier foils in such a way that, in response to a pressure acting on the active area of the switching element, the first and second carrier foils are pressed together against reaction force of the elastic carrier foils and an electrical contact is established between the at least two electrodes, wherein at least one of said electrodes is arranged on said first carrier foil,
said foil-type switching element further comprising a layer of dielectric material, said dielectric material being applied onto said first carrier foil between the first carrier foil and said electrode arranged on said first carrier foil, said layer of dielectric material covering at least a region of the first carrier foil which is delimited by a generally outer periphery of the electrode arranged on said first carrier foil.

19. The foil-type switching element according to claim 18, wherein at least one of said electrodes is arranged on said first carrier foil and wherein a layer of dielectric material is applied onto said second carrier foil between the second carrier foil and an electrode arranged on said second carrier foil.

20. The foil-type switching element according to claim 18, wherein said layer of dielectric material is applied on the first carrier foil in substantially an entire area of said active area.

21. The foil-type switching element according to claim 18, wherein said layer of dielectric material is applied on the first carrier foil in an entire area of said active area and extends laterally beyond said active area.

22. The foil-type switching element according to claim 18, wherein said layer of dielectric material is applied on the first carrier foil on a complete surface of said carrier foil.

23. The foil-type switching element according to claim 19, wherein said layer of dielectric material is applied on the second carrier foil in substantially an entire area of said active area.

24. The foil-type switching element according to claim 19, wherein said layer of dielectric material is applied on the second carrier foil in an entire area of said active area and extends laterally beyond said active area.

25. The foil-type switching element according to claim 19, wherein said layer of dielectric material is applied on the second carrier foil on a complete surface of said carrier foil.

26. The foil-type switching element according to claim 18, wherein said layer of dielectric material is printed onto said carrier foil.

27. The foil-type switching element according to claim 18, wherein a thickness of said layer of dielectric material varies over the active area.
